(19) United States
(12) Patent Application Publication
(10) Pub. No.: US 2011/0121044 A1
(43) Pub. Date: May 26, 2011

(54) Bicycle Mounted Aerodynamic Water Bottle, Spare Parts and Tools Storage Apparatus

(76) Inventor: Tom SCHOPF, STONEY CREEK (CA)

(21) Appl. No.: 12/780,576

(22) Filed: May 14, 2010

Related U.S. Application Data
(60) Provisional application No. 61/213,193, filed on May 15, 2009.

(51) Int. Cl. B62J 11/00

(52) U.S. Cl. 224/414

(57) ABSTRACT

A storage apparatus for a bicycle intended for placement between the down tube and seat tube of the frame of the bicycle. The storage apparatus has a driving wall, an opposing wall, and at least one side wall. The side wall extends perpendicularly from the driving wall and/or the opposing wall to a length that does not substantially exceed the frame tube diameter. The side wall resides between the driving wall and opposing wall when the apparatus is in the closed position. Items can thereby be stored between the driving wall and opposing wall of the apparatus and be conveniently accessed by the cyclist.

### PRIORITY CLAIM

This application claims the benefit of U.S. Provisional Patent Application Ser. No. 61/213,193, filed on May 15, 2009, the entire content of which is incorporated herein by reference.

### FIELD OF THE INVENTION

The present invention is a storage apparatus that can be mounted on a bicycle. The apparatus can be used for storing a standard water bottle and/or other fluid containers, as well as miscellaneous items such as spare parts, tools, medicine, food, personal identification, medical information (medical alert), and a cellular telephone.

### BACKGROUND OF THE INVENTION

In the sport of cycling, there is a need to carry supplies. Ideally, those supplies can be stored in a manner which does not interfere with the handling characteristics of the bicycle, provides rapid and convenient access to the stored items, and does not add substantial aerodynamic drag. In addition, it is preferred that the storage apparatus is generally light weight in order to reduce the weight being propelled by the cyclist. Furthermore, if the cyclist is competing in an organized competitive event, the supplies must be stored in a method which complies with the competitive event's governing body's rules. Various aspects of the needs that a cyclist may face are discussed further below.

1) The Need to Carry Supplies

a) In the field of bicycling, it may be the practice of cyclists to carry water or other beverages to quench thirst and rehydrate the body, especially during long rides or racing events. In addition, it may be the practice of cyclists to carry spare parts and tools. Spare parts include, for example, spare tire inner tubes and/or a tire inner tube patch repair kit. Tools include, for example, tire irons (sometimes called tire levers), used to remove the bicycle tire, and either an air pump or compressed gas canisters—typically referred to as “CO₂ cartridges”—used to inflate the bicycle tire. It is common for cycling race events to have a rule which states that a competitor cannot accept any parts or help from non-competitors if they have to repair their bicycle. In other words, they must do the repair themselves with the parts and tools they carry with them. Failure to comply with this racing rule can result in disqualification. Because of this racing event rule, cyclists are compelled to carry spare parts and tools.

b) Some cyclists suffer from severe allergic reaction and for safety purposes, need to carry their medical supplies. This is to prevent going into anaphylactic shock if they are exposed to an allergen while cycling.

2) The Need for Rapid and Convenient Access

a) In the event that a cyclist with severe allergy is exposed to an allergen, he/she must be able to access and administer his/her medicine (Epinephrine) as quickly as possible. Typically the need is to access and administer the medicine within 30 seconds.

b) If the cyclist is competing in an organized competitive event and experiences a flat tire, there is a competitive advantage to being able gain access to their spare parts and tools in as little time as possible.

3) The Need for Aerodynamics

In cycling, as the bicycle speed increases, so does the aerodynamic drag. It has been established that once the bicycle surpasses the speed of 12.8 km/h, the aerodynamic drag of a bicycle and cyclist is greater than the rolling resistance. Therefore any improvement in aerodynamics will result in the reduction of aerodynamic drag and the ability to maintain the same speed with less effort, or the increase of speed for the same effort. This provides a competitive advantage to a competitive cyclist in a bicycle race including the cycling portion of a triathlon, or allows a cyclist to travel further and/or faster using the same energy.

To illustrate the impact aerodynamics play in cycling performance, a bicycle had its aerodynamic drag measured and the power required to maintain a speed of 30 mph in a wind tunnel (A2 Wind Tunnels in North Carolina).

The Testing Protocol: Compared the aerodynamics of a (a) typical race bicycle with saddle bag (used to store spare parts and tools) and standard water bottle cage with water bottle to that of the (b) same bicycle without any storage apparatus. Testing used a wind speed of 30 mph and yaw angles (cross winds) from 0° to 25°, in 5° increments.

(a) Bicycle = Cervelo P2C equipped
with ZIPP wheels (808 front/Disk rear).

| Yaw | Body Axis | Body Axis | Drag | Drag | Aero |
|---|---|---|---|---|---|
| Angle | C_{D}A | C_{D} | lbs. | grams | Watts |
| 0° | .955 | .282 | 2.20 | 998 | 131 |
| 5° | .927 | .274 | 2.14 | 969 | 127 |
| 10° | .899 | .265 | 2.07 | 939 | 124 |
| 15° | .840 | .248 | 1.93 | 877 | 115 |
| 20° | .852 | .251 | 1.96 | 890 | 117 |
| 25° | .894 | .264 | 2.06 | 934 | 123 |

Tools, spare parts and hydration = one 28 oz. bottle stored on a stand water bottle cage and one spare tube, two CO₂ cartridges, one air chuck and three tire irons stored in a saddle bag mounted behind the bicycles saddle.

(b) Bicycle = Cervelo P2C equipped
with ZIPP wheels (808 front/Disk rear).

| Yaw | Body Axis | Body Axis | Drag | Drag | Aero |
|---|---|---|---|---|---|
| Angle | C_{D}A | C_{D} | lbs. | grams | Watts |
| 0° | .862 | .254 | 1.98 | 900 | 118 |
| 5° | .803 | .237 | 1.85 | 839 | 110 |
| 10° | .751 | .222 | 1.73 | 785 | 103 |
| 15° | .721 | .213 | 1.66 | 753 | 99 |
| 20° | .713 | .210 | 1.64 | 745 | 98 |
| 25° | .754 | .222 | 1.74 | 788 | 104 |

Tools, spare parts and hydration = none

4) The Need to Assure Bicycle Handing

Items stored on a bicycle can affect the bicycle's handling characteristics and the ability of the cyclist to control the bicycle. The higher and further from the bicycle's centre of gravity the stored items are, the greater the influence the stored items have due to weight and aerodynamic drag. Other facts include the strength of the wind and the angle in which it hits the bicycle (yaw or cross win). So that stored items have a minimum impact on a bicycle's handling, they need to be located as low as possible and as close as possible to the centre of gravity on the bicycle.

5) The Need for Weight Savings

The less weight a bicycle has, the faster it can accelerate and climb up a hill. Any apparatus that is added to a bicycle will add weight and have a negative affect on performance. Therefore, if an apparatus is required, there is value in assuring that it is as light weight as practical.

6) The Need to be Compliant

Because of the performance gains due to the application of aerodynamics, the governing bodies of cycling sport, primarily the UCI (International Cycling Union) and the ITU (International Triathlon Union), have rules outlining the application of aerodynamics which bicycles, bicycles parts and components, and cyclist clothing must comply with to be legal in their sanctioned events.

### SUMMARY OF THE INVENTION

The present invention provides an aerodynamic storage apparatus which can be mounted on a bicycle. The storage apparatus can hold, for example, spare parts and tools, and can also include means for aerodynamically storing a fluid container, such as a water bottle. These items can be stored in the storage apparatus of the present invention, which is an aerodynamically optimized, fast access, and light weight apparatus which does not infringe on any known UCI and ITU rules. The invention can also be used for recreational use to store such parts or to store additional items, including medicine, food, personal identification, medical information (medical alert items), a cellular telephone, and other products.

A water bottle can be held in place on the top of the apparatus through the use of two curved structures that follow the contour of the water bottle and provide enough friction to prevent the water bottle from falling out and yet not too much friction as to prevent the cyclist from either inserting or extracting the water bottle. It is preferable that the water bottle is stored so that the water bottle length (the distance from its top to its bottom) is held in the horizontal plane. This allows the water bottle to present the smallest surface area to the wind as the bicycle is travelling in the forward direction. In addition, the water bottle held in a horizontal plane provides less drag in a cross wind.

The present invention provides storage apparatus for connection to the frame of a bicycle, said apparatus having an open and closed position, and comprising a driving wall, for connecting a side of the apparatus to the side of the bicycle having the gears and chain, said driving wall having an edge to be associated with the down tube of the frame and an edge to be associated with the seat tube of the frame; an opposing wall, which can be releasably fastened to the driving wall, and is associated with the side of the bicycle which does not have the gears and chains, fastening means associated with the driving wall and the opposing wall, for releasably securing the driving wall to the opposing wall, and a side wall extending perpendicularly from the driving wall to a length that does not substantially exceed the frame tube diameter, said side wall residing between the driving wall and opposing wall when the apparatus is in the closed position, wherein the apparatus in the closed position comprises a storage area between the driving wall and the opposing wall, and can be secured within a bicycle frame between the down tube and the seat tube.

The driving wall may further comprise a means to secure a portable fluid container. The driving wall and the opposing wall may secure a potable fluid container when the apparatus is in a closed position.

The fastening means may comprise an elastic mechanism, or a hook and loop mechanism, or a metal clasp system, or a spring mechanism.

The driving wall and the opposing wall may be adapted to releasably secure a piece of elastic material, wherein the elastic material may be a rubber band.

The driving wall may comprise at least one flange for connecting the apparatus to the frame, where in the flange may extend from the driving wall edge to be associated with the down tube. Additionally, the flange may be adapted to be secured to the down tube or may be adapted to be secured to the down tube with two-sided adhesive tape. The flange may additionally extend from the driving wall edge to be associated with the seat tube and may be adapted to be secured to the seat tube or may adapted to be secured to the down tube with two-sided adhesive tape.

The driving wall and the opposing wall may each comprise at least one flange which may allows the apparatus to fit securely between the down tube and the seat tube when the apparatus is in the closed position. The side wall may extend to a length just over half of the frame tube diameter.

The opposing wall may further comprise a second side wall which may extend perpendicularly therefrom to a length that does not substantially exceed the frame tube diameter. The second side wall may reside between the driving wall and opposing wall when the apparatus is in the closed position, and may be sufficiently offset from the location of the side wall such that the side wall and second side wall can overlap when the apparatus is in the closed position.

The apparatus may be at least partially manufactured from a composite materials, and/or thermoset plastics, or thermoplastics.

To illustrate the impact that the apparatus has on aerodynamics and the improvement over standard storage methods, wind tunnel testing was conducted (A2 Wind Tunnels, N.C.).

The Testing Protocol: Compare the aerodynamics of (a) a typical race bicycle with saddle bag (used to store spare parts and tools) and standard water bottle cage with water bottle to (b) the same bicycle with the apparatus storing the same items and (c) the same bicycle without any storage apparatus or items. Testing used a wind speed of 30 mph and yaw angles (cross winds) from 0° to 25°, in 5° increments.

(a) Bicycle = Cervelo P2C equipped
with ZIPP wheels (808 front/Disk rear).

| Yaw | Body Axis | Body Axis | Drag | Drag | Aero |
|---|---|---|---|---|---|
| Angle | C_{D}A | C_{D} | lbs. | grams | Watts |
| 0° | .955 | .282 | 2.20 | 998 | 131 |
| 5° | .927 | .274 | 2.14 | 969 | 127 |
| 10° | .899 | .265 | 2.07 | 939 | 124 |
| 15° | .840 | .248 | 1.93 | 877 | 115 |
| 20° | .852 | .251 | 1.96 | 890 | 117 |
| 25° | .894 | .264 | 2.06 | 934 | 123 |

Tools, spare parts and hydration = one 28 oz. bottle stored on a stand water bottle cage and one spare tube, two CO₂ cartridges, one air chuck and three tire irons stored in a saddle bag mounted behind the bicycles saddle.

(b) Bicycle = Cervelo P2C equipped
with ZIPP wheels (808 front/Disk rear).

| Yaw | Body Axis | Body Axis | Drag | Drag | Aero |
|---|---|---|---|---|---|
| Angle | C_{D}A | C_{D} | lbs. | grams | Watts |
| 0° | .861 | .254 | 1.98 | 900 | 118 |
| 5° | .819 | .242 | 1.89 | 855 | 113 |
| 10° | .770 | .227 | 1.77 | 805 | 106 |
| 15° | .742 | .219 | 1.71 | 775 | 102 |
| 20° | .757 | .223 | 1.74 | 791 | 104 |
| 25° | .790 | .233 | 1.82 | 826 | 109 |

Tools, spare parts and hydration = one 28 oz. bottle, one spare tube, two CO₂ cartridges, one air chuck and three tire irons stored apparatus in accordance with an embodiment of the present invention.

(c) Bicycle = Cervelo P2C equipped
with ZIPP wheels (808 front/Disk rear).

| Yaw | Body Axis | Body Axis | Drag | Drag | Aero |
|---|---|---|---|---|---|
| Angle | C_{D}A | cd | lbs. | grams | Watts |
| 0° | .862 | .254 | 1.98 | 900 | 118 |
| 5° | .803 | .237 | 1.85 | 839 | 110 |
| 10° | .751 | .222 | 1.73 | 785 | 103 |
| 15° | .721 | .213 | 1.66 | 753 | 99 |
| 20° | .713 | .210 | 1.64 | 745 | 98 |
| 25° | .754 | .222 | 1.74 | 788 | 104 |

Tools, spare parts and hydration = none

The spare parts and tools can be stored in a container portion that is part of the apparatus underneath the water bottle holder structure. The storage space allows for the storage of items such as a spare tire tube, two compressed gas cartridges, multiple bicycle tire irons and an air chuck (an air chuck is a connector which couples a compressed gas cartridge to a bicycle tire tube valve stem). This storage space is not limited to the storage of the above items and can be used to store other items as well.

The apparatus allows for it's width to be adjustable. This allows the apparatus to be used in association with bicycles made by various manufacturers. With the width being adjustable and/or flexible, the spare parts and tools container can be the same thickness of the bicycle frame down tube and seat tube. By keeping the apparatus' spare parts and tools container within the thickness of the bicycle frame's tubes, the apparatus is sheltered from the wind as the bicycle is travelling in the forward direction.

The apparatus is to be fitted on the bicycle in the lower section of the bicycle frame between the down tube and the seat tube. This not only allows the apparatus to be positioned in an aerodynamically optimized position, but aids with the bicycle handling since it lowers the bicycle's centre of gravity.

According to an embodiment of the invention, the apparatus can consist of essentially two halves, with each half dedicated to a side of the bicycle. Half of the apparatus is attached to the drive side of the bicycle (the side which the drive gears and chain are located) and the other half, which is designed to fit on the non-drive side of the bicycle is attached to the affixed apparatus. The two halves can be secured using an elastic mechanism allowing the two halves the flexibility to contract or expand in width to accommodate bicycles of different frame tube diameters. In an embodiment of the invention, to open or close the apparatus, the elastic mechanism can have finger tabs moulded into it structure, thereby allowing it to be gripped by a cyclist with either greasy or sweaty fingers. In practice, the cyclist can grab the tabs in order to stretch the elastic mechanism over the hook/tabs that are part of the apparatus located on each of its three corners. Once the cyclist has “un-hooked” two of the three tabs, the apparatus will open. Closing the apparatus is the reversal of opening.

### BRIEF DESCRIPTION OF THE DRAWINGS

FIG. 1 is a side view of the storage apparatus according to an embodiment of the present invention mounted on a racing bicycle.

FIG. 2 is a cross-sectional side view of the storage apparatus according to an embodiment of the present invention.

FIG. 3 is a front view of the storage apparatus according to an embodiment of the present invention.

FIG. 4 is a close-up perspective view of the fastening mechanism of the storage apparatus according to an embodiment of the present invention.

FIG. 5 is a perspective view of the elastic mechanism of the storage apparatus according to an embodiment of the present invention.

FIG. 6 is a front view of the storage apparatus according to an embodiment of the present invention, shown with two sides separated for illustration purposes.

### DETAILED DESCRIPTION OF THE PREFERRED EMBODIMENTS

In accordance with the foregoing summary of the invention, the following presents a details description of a preferred embodiments of the invention. The following description of the preferred embodiments are merely exemplary in nature and is in no way intended to limit the invention, its application, or uses.

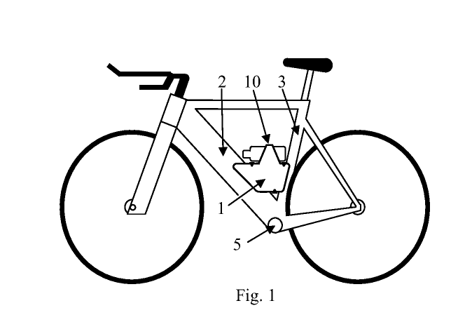

FIG. 1 shows a side view of storage apparatus 1 mounted on a bicycle between the bicycle's down tube 2 and the bicycle's seat tube 3. In the embodiment shown, apparatus 1 comprises fluid container holders 10, which can be used for storing a fluid container such as a standard water bottle. In a preferred embodiment, the apparatus can be mounted low in the frame, just above bottom bracket 5. The lower placement of apparatus 1 on the bicycle may lower the centre of gravity of the bicycle and thus improve stability compared to other storage systems that place the weight higher on the bicycle.

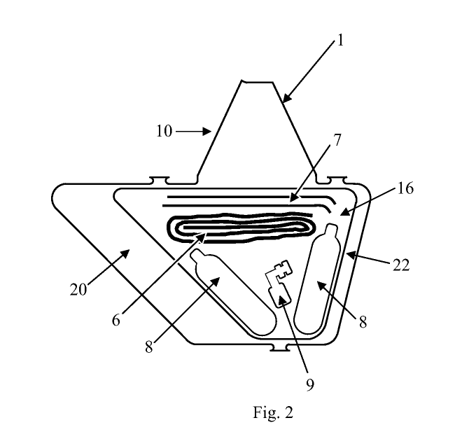

FIG. 2 shows apparatus 1 housing spare parts and tools within storage compartment 16. Spare parts and tools may include a spare tire inner tube 6, bicycle tire irons 7 used for removing/replacing the tire off/on the wheel rim, compressed gas cartridges 8 used to inflate the bicycle tires and an air chuck 9 used to couple the compressed gas cartridges to the bicycle tire inner tube air valve. Storage compartment 16 is not limited to the storage of the above items 6, 7, 8, and 9 and can be used to store other items as well. In addition, items 6, 7, 8, and 9 do not have to be stored in the layout as shown in FIG. 2, since this drawing illustrates an example of a possible layout. Further, the items can be secured inside apparatus 1 by any means known in the art, or can be arranged so that they are packed efficiently and/or held in place by the walls (discussed below) of apparatus 1. A water bottle can be held in place on the top of the apparatus through the use of holders 10, which can be curved structures that generally follow the contour of a water bottle and provide enough friction to prevent the water bottle from falling out and yet not too much friction as to prevent the cyclist from either inserting or extracting the water bottle. It is preferred that the water bottle is stored so that the water bottle length (the distance from its top to its bottom) is held in the horizontal plane. This allows the water bottle to present the smallest surface area to the wind as the bicycle is travelling in the forward direction and a reduction in aerodynamic drag due to less turbulence in cross winds (or yaw).

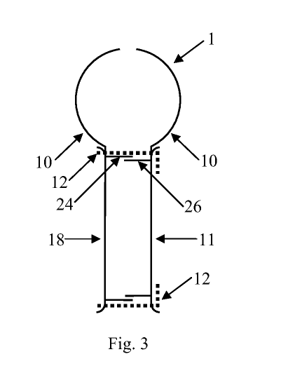

FIG. 3 shows a front view of apparatus 1 comprising driving wall 18 and opposing wall 11. Driving wall 18 is adapted to be attached to the drive side of the bicycle (the side which the drive gears and chain are located). Driving wall 18 comprises flanges 20 and 22 (shown in FIG. 2) for securing apparatus 1 to a bicycle frame. Apparatus 1 can be secured to a bicycle frame through any means known in the art. However, it is preferred that non-corroding materials be used since apparatus 1 may be subjected to wet weather and possibly other fluid sources. In a preferred embodiment, a suitable double-sided adhesive tape can be used to secure flange 20 and/or 22 to the frame of the bike. In practice, flange 20 can be secured to the down tube of a bicycle frame and flange 22 can be secured to the seat tube. It will be understood by those skilled in the art that flanges 20 and 22 need not extend an entire side of apparatus 1. For example, flanges 20 and 22 could function by extending from a smaller portion of a side of apparatus 1. In such a case, one or multiple flanges can be used and be suitable for the present invention.

In another embodiment, apparatus 1 can be mounted to the bicycle using the bicycle's water bottle cages bosses (two sets of threaded opening). In yet another embodiment, flanges or other securing devices need not be used if the shape of apparatus 1 allows it to sit sufficiently secured between down tube 2 and seat tube 3. or is secured using cable ties.

Driving wall 18 also comprises side wall 24, which extends generally perpendicularly from driving wall 18 and can be designed to be associated with corresponding side wall 26 of opposing wall 11 (discussed below) when apparatus 1 is in a closed position.

Further in FIG. 3, opposing wall 11 is designed to fit on the non-drive side of the bicycle. Opposing wall 11 can be releasably fastened to driving wall 18 through fastening mechanism 12. Fastening mechanism 12 can be any suitable mechanism known to those skilled in the art, such as hook and loop fasteners (example: Velcro™), metal clasps and springs. In a preferred embodiment, fastening mechanism 12 is a generally elastic mechanism which allows flexibility of the distance between driving wall 18 and opposing wall 11 so that apparatus 1 can contract or expand in width to accommodate bicycles of different frame tube diameters and the volume of spare parts and tools stored within.

When apparatus 1 is in a closed position, side walls 24 and 26 define the periphery of storage container 16. However, variations of such a storage container fall within the scope of this invention. For example, either side wall 24 or 26 may be absent, while the remaining side wall can be extended to cover substantially or all of the distance between driving wall 18 and opposing wall 11. In other embodiments, side walls 24 and 26 may not be continuous, but rather appear at strategic points along the periphery of storage container 16, to provide, for example, support for apparatus 1. In another embodiment, side walls 24 and 26 may be absent entirely. However, in a preferred embodiment, a side wall or side walls generally are present in apparatus 1 to protect the stored items from rain and other elements.

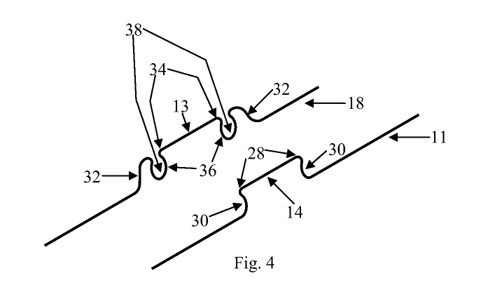

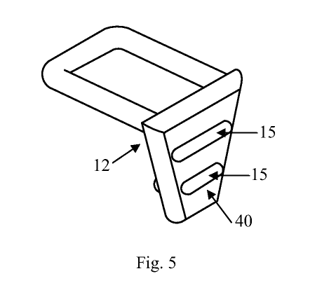

FIG. 4 is a close up view of a preferred of the fastening mechanism of the apparatus. In this embodiment, fastening mechanism comprises of tabs 13 and 14, which are used to secure the elastic mechanism 12 or the like (featured in FIG. 5). Tab 13 can form part of or be affixed to driving wall 18 and comprises neck 36, protrusion 34, and side flaps 32, which define opening 38. Tab 14 can form part of or be affixed to opposing wall 11 and comprises neck 30 and protrusion 28. The design of tab 13 can allow elastic mechanism or the like to be removed and reattached.

FIG. 5 is a close-up view of the elastic mechanism 12. Key to its design is a finger tab 40 combined with ridges 15 which can allow a cyclist with greasy or sweaty fingers to grip the elastic mechanism 12 so that the apparatus can be open or closed. The elastic mechanism 12 can be used as a fastening mechanism to fasten the driving wall 18 to the opposing wall 11 by being hooked over and encircling the tabs (tabs 13 and 14 featured in FIG. 4).

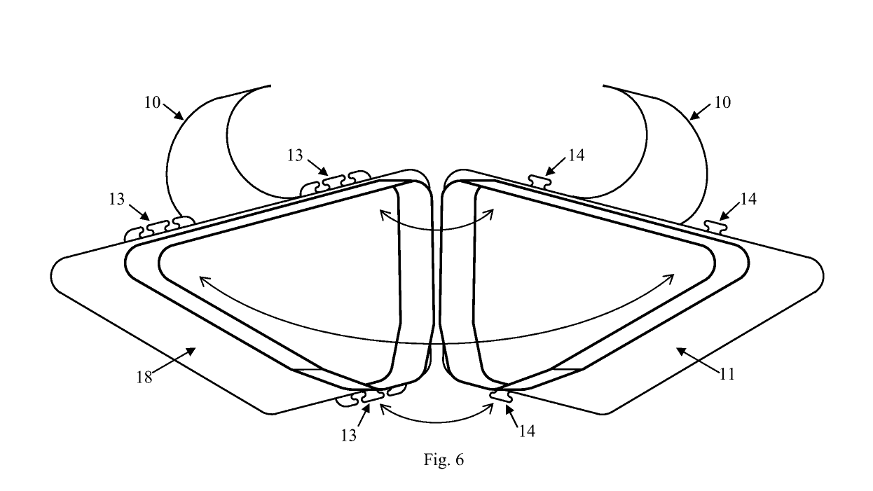

FIG. 6 is a front view of apparatus 1 according to an embodiment of the invention. Apparatus 1 is shown generally open in order to better describe an embodiment of the invention to the skilled person. In this embodiment, each opposing part of apparatus 1 is almost a mirror image of the other with the following exceptions: the opposing wall 11 side has its spare parts and tools storage container smaller than its mirrored counterpart so that it may fit within the driving wall 18 side spare parts and tools storage container, and tabs 13 for an elastic band or the like captures the elastic band in a way that prevents it from detaching from the driving wall 18 side.

The design of apparatus 1 allows for an aerodynamic profile when the bicycle is travelling in the forward direction and yet does not interfere with the cyclist legs while peddling. However, narrower or wider dimensions may be preferred where aerodynamics or storage capacities are overriding considerations.

Because of the variation in the angle formed by down tube 2 and seat tube 3, apparatus 1 has been designed to fit on the great majority of adult bicycles. Attention has been given to assure that it fits on time trial and triathlon bicycles since it is in these sports that aerodynamic provides a competitive advantage to the cyclist.

Apparatus 1 can be made of various materials, including composite materials such as carbon fibre, thermoset plastics and thermoplastics (in the use of injection moulding manufacturing).

Apparatus 1 can open in a variety of ways. One way, exemplified above, is for the use of a mechanism to be used with an elastic band or the like together with finger tabs 40.

The apparatus can be made in various sizes and shapes, provided that its size and shape are aerodynamically optimized and do not infringe on any known UCI and ITU rules. Where the apparatus is made for recreational use, compliance with UCI and ITU rules would be optional.

In one embodiment of the invention, the invention will be sold in association with the trademark, WEDGIE. In other embodiments of the invention, the invention may be sold in association with that, or various other, trademarks.

The exemplary embodiments disclosed herein are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description.

1. A storage apparatus for connection to the frame of a bicycle, said apparatus having an open and closed position, and comprising
a driving wall, for connecting a side of the apparatus to the side of the bicycle having the gears and chain, said driving wall having an edge to be associated with the down tube of the frame and an edge to be associated with the seat tube of the frame;
an opposing wall, which can be releasably fastened to the driving wall, and is associated with the side of the bicycle which does not have the gears and chains,
fastening means associated with the driving wall and the opposing wall, for releasably securing the driving wall to the opposing wall, and
a side wall extending perpendicularly from the driving wall to a length that does not substantially exceed the frame tube diameter, said side wall residing between the driving wall and opposing wall when the apparatus is in the closed position,
wherein the apparatus in the closed position comprises a storage area between the driving wall and the opposing wall, and can be secured within a bicycle frame between the down tube and the seat tube.

2. The apparatus according claim 1, wherein the driving wall further comprises means to secure a potable fluid container.

3. The apparatus according to claim 1, wherein the driving wall and the opposing wall are further adapted to secure a potable fluid container when the apparatus is in a closed position.

4. The apparatus according to claim 1, wherein the fastening means comprises an elastic mechanism, a hook and loop mechanism, Velcro™, a metal clasp system, or a spring mechanism.

5. The apparatus according to claim 1, wherein the driving wall and the opposing wall are adapted to releasably secure a piece of elastic material.

6. The apparatus according to claim 5, wherein the elastic material is a rubber band.

7. The apparatus according to claim 1, wherein the driving wall comprises at least one flange for connecting the apparatus to the frame.

8. The apparatus according to claim 7, wherein the flange extends from the driving wall edge to be associated with the down tube.

9. The apparatus according to claim 8, wherein the flange is adapted to be secured to the down tube.

10. The apparatus according to claim 9, wherein the flange is adapted to be secured to the down tube with two-sided adhesive tape.

11. The apparatus according to claim 7, wherein the flange extends from the driving wall edge to be associated with the seat tube.

12. The apparatus according to claim 11, wherein the flange is adapted be secured to the seat tube.

13. The apparatus according to claim 12, wherein the flange is adapted to be secured to the down tube with two-sided adhesive tape.

14. The apparatus according to claim 1, wherein the driving wall and the opposing wall each comprise at least one flange which allows the apparatus to fit securely between the down tube and the seat tube when the apparatus is in the closed position.

15. The apparatus according to claim 1, wherein the side wall extends to a length just over half of the frame tube diameter.

16. The apparatus according to claim 1, wherein the opposing wall further comprises a second side wall extending perpendicularly therefrom to a length that does not substantially exceed the frame tube diameter, said second side wall residing between the driving wall and opposing wall when the apparatus is in the closed position, and said second side wall being sufficiently offset from the location of the side wall such that the side wall and second side wall can overlap when the apparatus is in the closed position.

17. The apparatus according to claim 1, wherein the apparatus is at least partially manufactured from a composite material.

18. The apparatus according to claim 17, where in the composite material is carbon fibre, aramids, e-glass, thermoset plastic, or thermoplastics.
